(19) United States
(12) Patent Application Publication
(10) Pub. No.: US 2006/0104352 A1
(43) Pub. Date: May 18, 2006

(54) Block matching in frequency domain for motion estimation

(75) Inventors: Yung-Sen Chen, Panchiao (TW); De-Yu Kao, Taipei (TW); Ying-Yuan Tang, Panchiao (TW)

Correspondence Address: BACON & THOMAS, PLLC, 625 SLATERS LANE, FOURTH FLOOR, ALEXANDRIA, VA, 22314, US

(73) Assignee: Princeton Technology Corporation, Hsin Tien (TW)

(21) Appl. No.: 10/989,270

(22) Filed: Nov. 17, 2004

(51) Int. Cl. H04N 11/04; H04B 1/66; H04N 7/12; H04N 11/02

(52) U.S. Cl. 375/240.03; 375/240.24; 375/240.2; 375/240.12

(57) ABSTRACT

The invention provides a method to reduce the computation complexity by performing the motion estimation in the frequency domain with tiny hardware overhead and a little modification of the video compression algorithms. Since human eyes are not so sensitive in the high frequency range as in the low frequency range, the present invention only takes low frequency information for finding the motion vector in motion estimation.

### FIELD OF THE INVENTION

The invention relates to a method of using the low frequency information to generate the motion vectors for the block matching in motion estimation. The block matching processes only apply to the low frequency, but not to the whole frequency range, so as to reduce the computation complexity in digital-animation calculation.

### BACKGROUND OF THE INVENTION

As to the digital-animation processing on the screens of computer, TV, mobile phone and the like, technologies for digital-animation compression have been used to reduce the memory space or the transmission bandwidth. The digital-animation compression technology has multiple formats, including MPEG-2, MPEG-4, AVS and H.264, all these formats use “motion estimation” to compress data in temporal dimensions. Normally, a consecutive animation should be played 20-30 frames per second so as to keep the frames running smoothly, and the motion relationship between two frames is determined by motion estimation.

One of the motion estimation methods is to divide the frame into MBs (Macro-Blocks) of 16×16=256 pixels (or different sizes in variant protocols), and then to find out an optimal motion vector that is related to the previous frame for each of the MBs. With reference to FIG. 1, wherein frame A and frame B are two frames, however, when transmitting (or saving) the frame B, only the motion vector (indicated by the dotted arrow) of the train needs to be transmitted, and then the frame B is re-generated just by adding the background covered by the train in frame A and cooperating with the stored data of the train and the background. This methods is able to substantially reduce the transmission bandwidth (or reduce the volume of memory), however, it increases the complexity of the calculation.

When calculating the motion vector of a certain MB in frame A, it must subtract the respective pixels of the MB in frame A by the corresponding pixels of a certain MB in frame B (full search method), and then add the 256 absolute differences together so as to get a “sum of absolute differences (SAD). In this case, many SADs are produced when calculating all the MBs in frame B, and the location of a comparative point corresponding to a minimum SAD is the target point. A location difference of the target point relative to the comparative point in frame A is the so-called “motion vector”. To reduce the calculation workload, initially a small searching range is defined and if the SAD found in the small searching range is less than a preset value (threshold value), then the location difference to the comparative point is the so-called motion vector.

Referring to FIG. 2, based on the full search of motion estimation and the searching range is 32×32 pixels, the size of MB is 16×16, if we want to find a motion vector of a certain MB, the certain MB and all the other MBs should be calculated, thus there will be 17×17=289 MB comparisons (MB is only allowed to move in a range of 17×17). Each comparison is processed based on the method of “Minimum sum of Absolute Differences” (MAD). Initially a pixel value of a MB is subtracted by a corresponding pixel value of another MB and then to get the absolute value, and then get the sum of the absolute value, which totally needs 767 operations (subtraction 256 operations, getting absolute value 256 operations, summation 255 operations, 256+256+255=767). There are 289 MB comparisons, each comparison needs 767 operations, and thereby it totally needs 289×767=221,663 operations to find a motion vector of a MB.

A frame includes 720×480 pixels, which can be divided into 1350 MBs. In this case, it totally needs 2.99×10⁸ (1350×221663) operations to finish the motion vectors calculation of this frame. A consecutive animation is usually played at 22 frames per second; thereby the total operation rate is about 6.58×10⁹ operations per second (22×2.99×10⁸).

From the above description, we found the motion estimation needs huge computation power. The system should be equipped with high system clock and large DSP, accordingly the power consumption is high and the battery of portable electronic instruments is unable to support the load, and the cost is increased. Thus, many new solutions have been developed and which are divided into two categories: first, to reduce the number of the comparative points, second, to reduce the operations. Both approaches can be applied at the same time so as to reduce the calculation workload to the least.

Many solutions can be used to reduce the comparative points, including “three step search” (TSS), “four step search” (FSS), etc, which are used to find several points in a preset searching range and figure out the minimum MAD value, and then process a region calculation around the minimum MAD.

Solutions used to reduce the operations are relatively few. Inequality shown as below is one of them.
SUM(ABS(a−b))>=ABS(SUM(a)−SUM(b))

wherein “a” and “b” represent the pixel value of the respective points of two MBs. The meaning of this inequality is that the sum of absolute difference between the corresponding pixel value of two MBs (MAD calculation) is greater than or equal to the absolute difference between the respective sum of the pixel value of the two MBs (it is called rough calculation).

All of the above-mentioned methods are applied in the timing domain. However, after the time domain to frequency domain transformation, we found that the block matching algorithm can be further improved.

### BRIEF DESCRIPTION OF THE DRAWINGS

FIG. 1 shows the motion vector in motion estimation.

FIG. 2 shows an illustrative diagram of the full search motion estimation of the prior art.

FIG. 3 shows a typical block diagram used in video compression for an MPEG4 system.

FIG. 4 shows a sample picture for video compression.

FIG. 5 shows the DCT transformation result of the sample picture.

FIG. 6 shows the zigzagging order in DCT transformation.

FIG. 7 shows the proposed system block diagram used in video compression in accordance with the present invention.

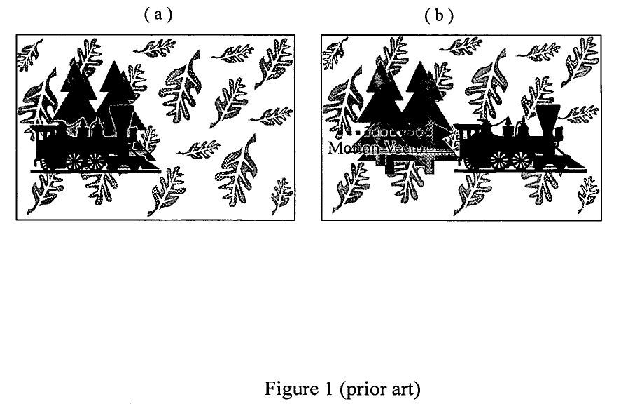

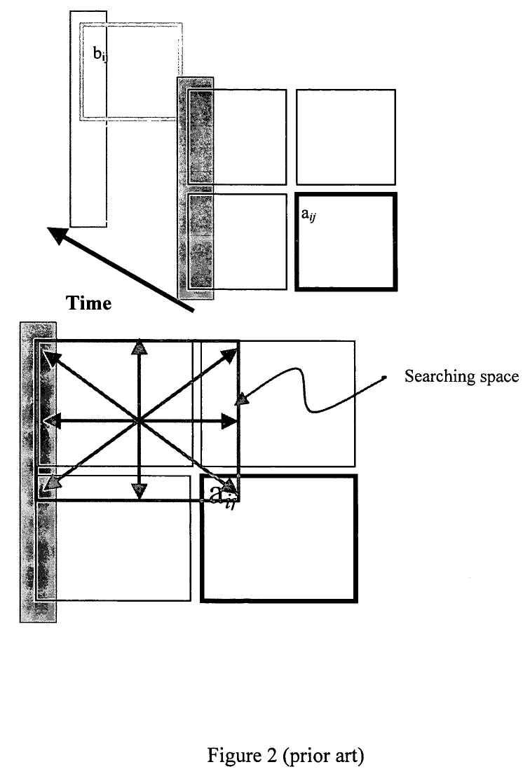

### DETAILED DESCRIPTION OF THE INVENTION

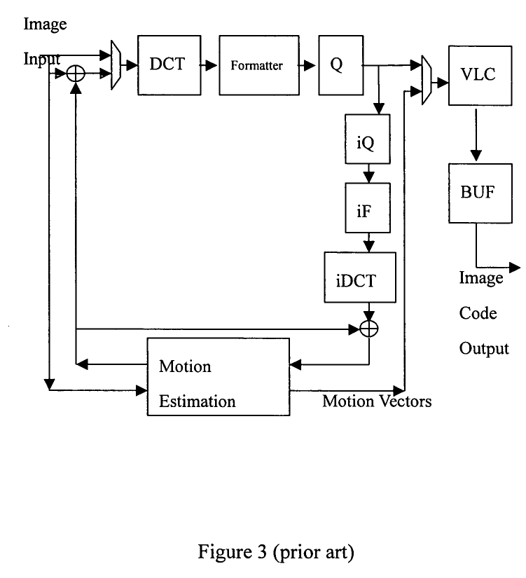

Most of the current video standards use different algorithms to compress data. Since human eyes are not so sensitive in the high frequency range as in the low frequency range, most of the video compression standards use DCT (Discrete Cosine Transfer) process to transform an image input from time domain to frequency domain; then formatting the data from dc, low frequency, to the high frequency; applying quantization to reduce the high frequency redundancies; using VLC (Variable Length Coding) to reduce the redundancies in the coding space; and finally using motion estimation to reduce the redundancies between pictures. Please refer to FIG. 3 and find a typical block diagram for an MPEG-4 system.

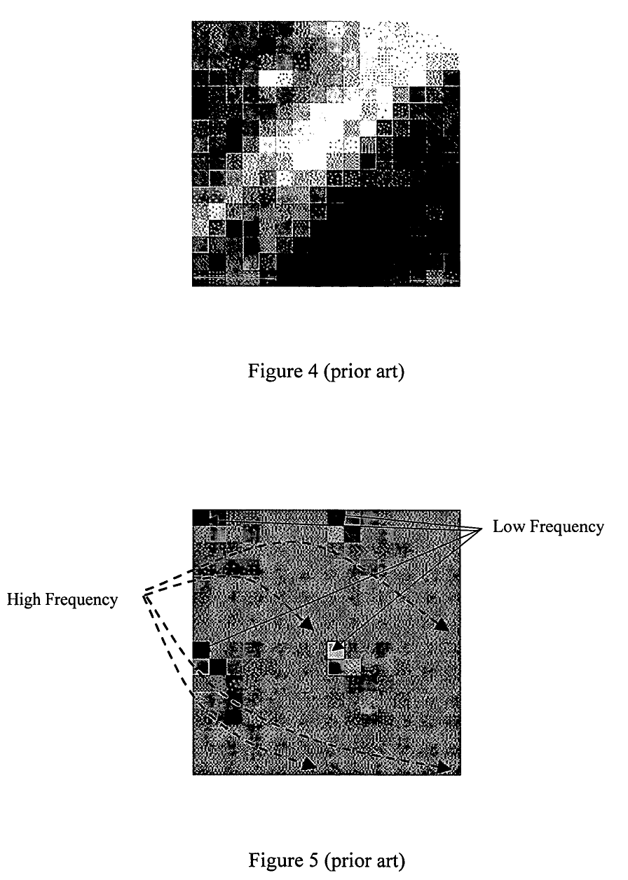

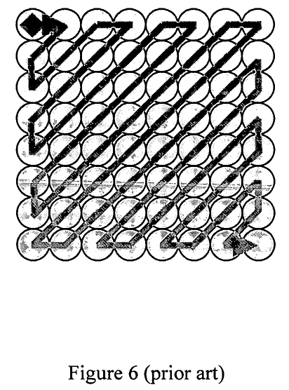

Referring to FIGS. 4 and 5, which showed sample pictures in video compression. The video compression uses DCT to transform the image of the sample picture from time domain (FIG. 4) to frequency domain (FIG. 5), formatting data from dc, low frequency, to the high frequency by zigzagging/alternative (please refer to FIG. 6); then using quantization block (“Q” of FIG. 3) to compress the human insensitive high frequency information, finally using the VLC to compress data in the coding space, and output the image code through a buffer (FIG. 3). To temporal compression, the ME (Motion Estimation)/block matching is finished after inverse quantization (iQ), inverse formatting (iF, inverse zigzagging/alternative), and the inverse DCT (iDCT), please refer to FIG. 3 again. After all information has been recovered in the timing domain, then the block matching algorithm in the motion estimation is applied to the data in the timing domain.

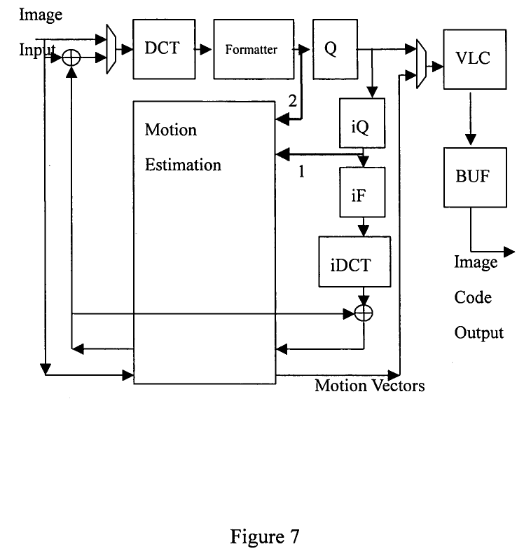

Referring to FIG. 7, the present invention proposes a new method. Since all of the block matching algorithms could be applied in the frequency domain, the motion estimation could be performed before the iDCT process as shown by the two arrows 1 and 2 in FIG. 7. Only the low frequency is sensitive to the human eyes, we only compare the low frequency information to find the optimal matching point and drop the high frequency information. For example, we could just take the first 8 bits out of each total 64 bits in 8×8 DCT block (FIG. 5) for the motion estimation, and then the computation complexity will be reduced to 12.5% of the original calculation. If it's necessary, partial of the motion estimation processes could be finished after the iDCT. Since all the comparison algorithms can be applied in the frequency domain as in the time domain, and the comparison points have been cut down by deleting the high frequency information, the total computation complexity could be reduced.

Using existing blocks/algorithms, this invention changes the order of the processing sequence thereby achieving the reduction of the computation bandwidth.

The spirit and scope of the present invention depend only upon the following claims, and are not limited by the above embodiment.

What is claimed is:

1. A method of block matching in frequency domain for motion estimation, motion estimation is used to determine a motion relationship between identical images in two digital-animation frames; video compression uses DCT (Discrete Cosine Transfer) process to transform an image input from time domain into a data of frequency domain, then formatting said data from dc, low frequency, to high frequency, applying quantization to reduce the high frequency redundancies in said data; said method comprises that after said quantization, said motion estimation are applied to said data of two digital-animation frames for achieving the reduction of computation.
